(19) United States
(12) Patent Application Publication
(10) Pub. No.: US 2016/0071060 A1
(43) Pub. Date: Mar. 10, 2016

(54) PROACTIVE OUT OF OFFICE NOTIFICATION

(71) Applicant: International Business Machines Corporation, Armonk, NY (US)

(72) Inventors: Adam C. Geheb, Nashua, NH (US); Prasanna R. Joshi, Pune (IN); Apurva S. Patel, Pune (IN)

(21) Appl. No.: 14/699,281

(22) Filed: Apr. 29, 2015

Related U.S. Application Data
(63) Continuation of application No. 14/477,271, filed on Sep. 4, 2014.

(51) Int. Cl. G06Q 10/10; H04L 12/58

(52) U.S. Cl. CPC G06Q 10/107; H04L 51/02; H04L 51/20

(57) ABSTRACT

In an approach to out of office notification, one or more computer processors receive an electronic communication from a sender to a recipient. The one or more computer processors determine an organization associated with the recipient. The one or more computer processors determine whether an organization timing rule for out of office notification exists for the organization. Responsive to determining an organization timing rule for out of office notification exists, the one or more computer processors determine whether the recipient has a planned absence. The one or more computer processors determine whether the recipient's planned absence meets a requirement of the organization timing rule. Responsive to determining the recipient's planned absence meets a requirement of the organization timing rule, the one or more computer processors send an out of office notification to the sender.

### TECHNICAL FIELD

The present invention relates generally to the field of electronic messaging, and more particularly to proactive out of office notification.

### BACKGROUND OF THE INVENTION

The use of email messages is commonplace for personal and business use. Individuals use email messages to keep in touch with and communicate with other users. Additionally, email messages provide a medium to collaborate and exchange documents. An email sender may not be aware of when an email recipient is absent or does not have access to email. Email systems provide a method for a notification of availability status to be sent in response to incoming email to a user. This notification is commonly called the “out of office” (OOO) feature.

### SUMMARY

Embodiments of the present invention disclose a method for out of office notification. The method for out of office notification may include one or more computer processors receiving an electronic communication from a sender to a recipient. The one or more computer processors determine an organization associated with the recipient. The one or more computer processors determine whether an organization timing rule for out of office notification exists for the organization. Responsive to determining an organization timing rule for out of office notification exists, the one or more computer processors determine whether the recipient has a planned absence. The one or more computer processors determine whether the recipient's planned absence meets a requirement of the organization timing rule. Responsive to determining the recipient's planned absence meets a requirement of the organization timing rule, the one or more computer processors send an out of office notification to the sender.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of an out of office notification program, on a server computer within the distributed data processing environment of FIG. 1, for proactive out of office notification, in accordance with an embodiment of the present invention; and

FIG. 3 depicts a block diagram of components of the server computer executing the out of office notification program, in accordance with an embodiment of the present invention.

### DETAILED DESCRIPTION

Existing out of office solutions employ a reactive notification. The participants only become aware of a counterparts' absence when an out of office (OOO) message is received in response to a sent email. It is possible that the sender has invested much effort and some degree of urgency in writing an email without realizing the recipient is unavailable. This often leads to decreased productivity as well as unnecessary use of resources such as network bandwidth and storage. In addition, the OOO functionality informs the sender of the recipient's absence if the email is received after the OOO functionality is enabled. If the sender sends an email to the recipient just prior to the recipient's absence, and the recipient does not respond before leaving, the sender may only become aware of the recipient's absence if a follow up email is sent.

Embodiments of the present invention recognize that productivity can be improved by proactively notifying email senders of a recipient's upcoming absence. Implementation of embodiments of the invention may take a variety of forms, and exemplary implementation details are discussed subsequently with reference to the Figures.

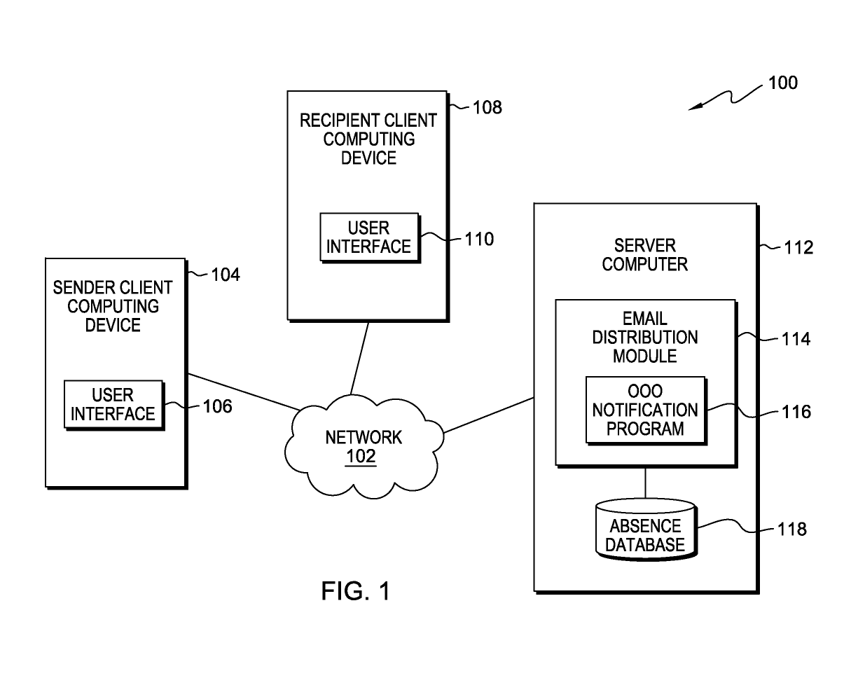

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes sender client computing device 104, recipient client computing device 108, and server computer 112, all interconnected over network 102. Network 102 can be, for example, a telecommunications network, a local area network (LAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information.

Sender client computing device 104 may be a desktop computer, a laptop computer, a tablet computer, a specialized computer server, a smart phone, or any programmable electronic device capable of communicating with recipient client computing device 108 and server computer 112 via network 102 and with various components and devices within distributed data processing environment 100. In general, sender client computing device 104 represents any programmable electronic device or combination of programmable electronic devices capable of executing machine readable program instructions and communicating with other computing devices via a network, such as network 102. Sender client computing device 104 includes user interface 106.

User interface 106 provides an interface between a user of sender client computing device 104 and server computer 112. User interface 106 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program. User interface 106 may also be mobile application software that provides an interface between a user of sender client computing device 104 and server computer 112. Mobile application software, or an “app”, is a computer program designed to run on smart phones, tablet computers and other mobile devices. User interface 106 enables a user of sender client computing device 104 to send and receive email.

Recipient client computing device 108 may be a desktop computer, a laptop computer, a tablet computer, a specialized computer server, a smart phone, or any programmable electronic device capable of communicating with sender client computing device 104 and server computer 112 via network 102 and with various components and devices within distributed data processing environment 100. In general, recipient client computing device 108 represents any programmable electronic device or combination of programmable electronic devices capable of executing machine readable program instructions and communicating with other computing devices via a network, such as network 102. Recipient client computing device 108 includes user interface 110.

User interface 110 provides an interface between a user of recipient client computing device 108 and server computer 112. User interface 110 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program. User interface 110 may also be mobile application software that provides an interface between a user of recipient client computing device 108 and server computer 112. Mobile application software, or an “app”, is a computer program designed to run on smart phones, tablet computers and other mobile devices. User interface 110 enables a user of recipient client computing device 108 to send and receive email.

Server computer 112 may be a management server, a web server, or any other electronic device or computing system capable of receiving and sending data. In other embodiments, server computer 112 may represent a server computing system utilizing multiple computers as a server system, such as in a cloud computing environment. In another embodiment, server computer 112 may be a laptop computer, a tablet computer, a netbook computer, a personal computer (PC), a desktop computer, a personal digital assistant (PDA), a smart phone, or any programmable electronic device capable of communicating with sender client computing device 104 and recipient client computing device 108 via network 102. In another embodiment, server computer 112 represents a computing system utilizing clustered computers and components to act as a single pool of seamless resources. Server computer 112 includes email distribution module 114 and absence database 118.

Email distribution module 114 is the portion of an email system that monitors incoming email traffic and routes outgoing responses within an organization. Email distribution module 114 includes the capability of setting an organization timing rule for proactive OOO notification. The timing rule for proactive OOO notification defines a threshold of time, prior to the absence of a member of the organization, for which a proactive response is provided. For example, a rule may be set such that if a member plans a leave for two weeks or more, any email received three working days prior to the start of the leave gets a proactive OOO notification. An organization may consist of an entire company or subsets within a company. For example, a project team, a geographic location, or a department may be considered an organization. In some embodiments, each organization defines the timing rule that best suits the functionality of the organization. In such embodiments, the organization's leader or administrator, or other designated organization member, sets the organization timing rule. An organization whose members are depended on for quick, urgent responses may set a timing rule for proactive OOO notification that is longer than an organization whose members are mostly autonomous. For example, members of a project team working to a deployment deadline may have a timing rule that provides proactive OOO notification one week before the member's planned absence so there is ample time to find a backup member for an emergency task. Email distribution module 114 includes out of office (OOO) notification program 116.

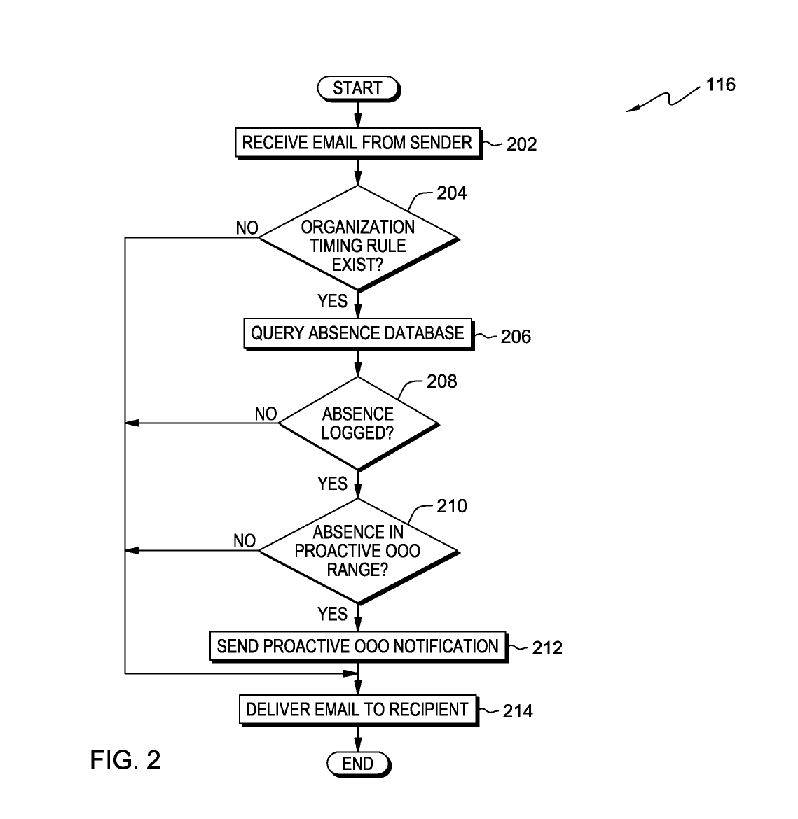

OOO notification program 116 resides in email distribution module 114. In another embodiment, OOO notification program 116 may reside elsewhere in server computer 112. In a further embodiment, OOO notification program 116 may reside on recipient client computing device 108 or elsewhere within distributed data processing environment 100, provided that OOO notification program 116 can communicate with email distribution module 114 over network 102. OOO notification program 116 monitors a recipient's email to determine if the recipient plans an upcoming absence and provides proactive notification to the email sender. OOO notification program 116 determines whether an organization timing rule for proactive notification exists for the recipient's organization. OOO notification program 116 determines if the recipient has logged an upcoming absence and whether that absence is in the proactive OOO notification range. If the recipient's upcoming absence is in the proactive OOO notification range, then OOO notification program 116 notifies the sender of the recipient's upcoming absence. In one embodiment, OOO notification program 116 operates within an email system. In other embodiments, OOO notification program 116 may operate within any system that provides communication between two or more users. For example, OOO notification program 116 may be used within a text messaging system, an instant messaging system, or a telephony system. OOO notification program 116 is depicted and described in further detail with respect to FIG. 2.

Absence database 118 resides on server computer 112. In another embodiment, absence database 118 may reside on sender client computing device 104, on recipient client computing device 108, or elsewhere in the environment. A database is an organized collection of data. Absence database 118 can be implemented with any type of storage device capable of storing data that may be accessed and utilized by server computer 112, such as a database server, a hard disk drive, or a flash memory. In other embodiments, absence database 118 can represent multiple storage devices within server computer 112. Absence database 118 stores electronic digital records of personnel and associated planned and completed absences for querying and referencing. Members of an organization log planned absences in absence database 118. Absence database 118 may be a simple database or absence database 118 may be a third party human resources tool. Absence database 118 may also be integrated into an email system with access to a user's calendar.

FIG. 2 is a flowchart depicting operational steps of out of office (OOO) notification program 116, on server computer 112 within distributed data processing environment 100 of FIG. 1, for proactive out of office notification, in accordance with an embodiment of the present invention.

OOO notification program 116 receives an email from a sender (step 202). When a sender, such as the user of sender client computing device 104, sends an email to a recipient, such as the user of recipient client computing device 108, through email distribution module 114, OOO notification program 116 monitors emails passing through email distribution module 114 in order to identify relevant recipient information, such as organizational affiliations, before the email is delivered to the recipient.

OOO notification program 116 determines whether an organization timing rule exists (decision block 204). OOO notification program 116 determines the one or more organizations in which the recipient is a member, and determines whether an organization timing rule exists for the recipient's organization(s). Determination of organizations in which the recipient is a member may be achieved by noting the recipient's email address or other identifiers. The organization timing rule may include a threshold of time prior to a recipient's planned absence and a duration of a recipient's planned absence. If OOO notification program 116 determines that no organization timing rule exists (“no” branch, decision block 204), then OOO notification program 116 delivers the email to the recipient (step 214).

If OOO notification program 116 determines that an organization timing rule does exist (“yes” branch, decision block 204), then OOO notification program 116 queries absence database 118 (step 206). OOO notification program 116 queries absence database 118 for any planned absences logged by or for the recipient.

OOO notification program 116 determines whether any absence is logged by or for the recipient (decision block 208). If OOO notification program 116 determines that no planned absence is logged by or for the recipient (“no” branch, decision block 208), then OOO notification program 116 delivers the email to the recipient (step 214).

If OOO notification program 116 determines that a planned absence is logged by or for the recipient (“yes” branch, decision block 208), then OOO notification program 116 determines whether the logged absence is in the proactive OOO notification range (decision block 210). OOO notification program 116 refers to the organization timing rule to determine whether the recipient's logged absence is within the range of time for which a proactive OOO notification is sent. For example, if a recipient logged an upcoming absence that starts in one week, OOO notification program 116 determines if the organization timing rule applies for less than or equal to one week.

If OOO notification program 116 determines that the logged absence is in the proactive OOO range (“yes” branch, decision block 210), then OOO notification program 116 sends a proactive OOO notification to the sender (step 212). For example, if a recipient has logged an absence that begins in two days, and the organization timing rule is less than or equal to one week, then OOO notification program 116 sends a proactive notification to the sender to alert the sender that the recipient begins an absence in two days. In one embodiment, OOO notification program 116 may also include information regarding the recipient's available free time before the absence begins to give the sender a sense of whether the recipient can complete a requested task before the recipient's absence begins. OOO notification program 116 may determine information regarding the recipient's available free time by querying the recipient's calendar. In an embodiment where OOO notification program 116 is used within a telephony system, OOO notification program 116 may send a proactive OOO notification to the caller by leaving a voicemail for the caller that indicates the recipient's absence begins in two days. OOO notification program 116 delivers the email to the recipient (step 214).

If OOO notification program 116 determines that the logged absence is not in the proactive OOO range (“no” branch, decision block 210), then OOO notification program 116 delivers the email to the recipient (step 214). For example, if a recipient has logged an absence that begins in two weeks, and the organization timing rule is less than or equal to one week, then OOO notification program 116 delivers the email to the recipient without sending a proactive notification to the sender.

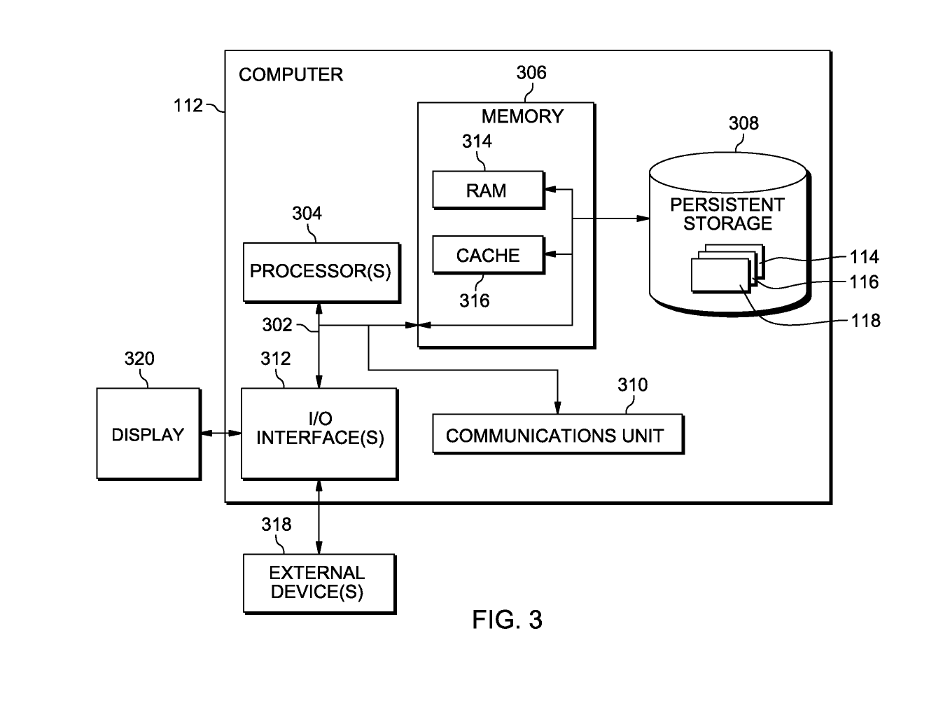

FIG. 3 depicts a block diagram of components of server computer 112 executing OOO notification program 116, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Server computer 112 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

Email distribution module 114, OOO notification program 116, and absence database 118 are stored in persistent storage 308 for execution and/or access by one or more of the respective computer processor(s) 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of sender client computing device 104 and recipient client computing device 108. In these examples, communications unit 310 includes one or more network interface cards. Communications unit 310 may provide communications through the use of either or both physical and wireless communications links. Email distribution module 114, OOO notification program 116, and absence database 118 may be downloaded to persistent storage 308 through communications unit 310.

I/O interface(s) 312 allows for input and output of data with other devices that may be connected to server computer 112. For example, I/O interface(s) 312 may provide a connection to external device(s) 318 such as a keyboard, a keypad, a touch screen, a microphone, a digital camera, and/or some other suitable input device. External device(s) 318 can also include portable computer readable storage media such as, for example, thumb drives, portable optical or magnetic disks, and memory cards. Software and data used to practice embodiments of the present invention, e.g., email distribution module 114, OOO notification program 116, and absence database 118, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for out of office notification, the method comprising:
receiving, by one or more computer processors, an electronic communication from a sender to a recipient;
determining, by the one or more computer processors, an organization associated with the recipient;
determining, by the one or more computer processors, whether an organization timing rule for out of office notification exists for the organization;
responsive to determining an organization timing rule for out of office notification exists, determining, by the one or more computer processors, whether the recipient has a planned absence;
determining, by the one or more computer processors, whether the recipient's planned absence meets a requirement of the organization timing rule; and
responsive to determining the recipient's planned absence meets a requirement of the organization timing rule, sending, by the one or more computer processors, an out of office notification to the sender.

2. The method of claim 1 wherein the organization includes: a company, a subset of a company, a department, a project team, or a geographic location.

3. The method of claim 1, wherein the organization timing rule for out of office notification includes at least one of: a threshold of time prior to a recipient's planned absence for which an out of office notification is sent and a duration of a recipient's planned absence for which an out of office notification is sent.

4. The method of claim 1, wherein determining, by the one or more computer processors, whether the recipient has a planned absence further comprises determining, by the one or more computer processors, whether the recipient has logged a planned absence in a database.

5. The method of claim 4, wherein determining, by the one or more computer processors, whether the recipient has logged a planned absence in a database further comprises querying, by the one or more computer processors, the database for the recipient's planned absence.

6. The method of claim 1, wherein the electronic communication includes: an email, a text message, an instant message, or a voicemail.

7. The method of claim 1, wherein the out of office notification includes one or more of: a notification of the recipient's planned absence, a date the recipient's planned absence begins, a date the recipient's planned absence ends, the recipient's free time between when the electronic communication was sent and a date the recipient's planned absence begins.
